(19) United States
(12) Patent Application Publication
(10) Pub. No.: US 2003/0030241 A1
(43) Pub. Date: Feb. 13, 2003

(54) INTERGRATED CROSS-CAR SUSPENSION SYSTEM WITH DAMPER STRUT

(76) Inventor: Robert Christian Lawson, Ann Arbor, MI (US)

Correspondence Address: Steven W. Hays, Artz & Artz, PC, Suite 250, 28333 Telegraph Road, Southfield, MI, 48034, US

(21) Appl. No.: 09/928,534

(22) Filed: Aug. 13, 2001

(51) Int. Cl. B60G 1/00; B62D 1/00

(52) U.S. Cl. 280/93.512; 280/124.142

(57) ABSTRACT

A cross-car suspension system with MacPherson strut replaces the lower control arms, coil springs, and anti-roll bar assembly in the prior art with a simple composite beam. By carefully designing the shape of the beam, the material system and the pivot locations, the ride and roll stiffness and camber and toe characteristics of the original prior art suspension system can be preserved while significantly reducing weight.

### TECHNICAL FIELD

The present invention relates generally to wheel suspension systems for motor vehicles, and more particularly, to an integrated cross-car suspension system with MacPherson strut.

### BACKGROUND ART

A suspension system on an automobile works with the tires, frame or unit body, wheels, wheel bearings, brake system, and steering system to provide a safe and comfortable mode of transportation. A suspension system has several important functions, including supporting the various components of an automobile, allowing the tires to move up and down to provide a comfortable ride, allowing for rapid cornering without extreme body roll, keeping the tires on the road surface, preventing excessive body squat when accelerating, preventing excessive body dive when braking, allowing the front wheels to turn side-to-side for steering, and, in combination with the steering system, keeping the wheels in correct alignment.

These suspension systems use front and rear springs to suspend a vehicle's frame, body or unitized body, engine, and powertrain above the wheels. These relatively heavy assemblies constitute what is known as “sprung” weight. The “unsprung” weight, on the other hand, includes wheels and tires, brake assemblies, and other structural members not supported by the springs. Unfortunately, high “unsprung” weight may result in adverse vehicle characteristics. Reduction of “unsprung” weight, therefore, is desirable.

The MacPherson strut system is used on most subcompact and compact cars with front wheel drive. A typical MacPherson strut front suspension system features long shock absorber struts surrounded by coil springs. Lower control arms, wheel spindles, knuckles, a stabilizer bar, and tie rods are part of the MacPherson design.

Many front and rear suspension systems incorporate compression type coil springs. Some front and rear coil springs are mounted between a lower control arm and spring housing or seat in the vehicle frame or body. Coil springs are made of steel or steel alloy and may have evenly or variably spaced coils to provide a comfortable ride while maintaining vehicle stability under all intended load conditions. Unfortunately, compression type coil springs are typically heavy and require significant packaging space within a vehicle.

In addition, an anti-roll bar is usually attached from the suspension lower control arm to the frame side rail to prevent sway (roll motion) of the body. Unfortunately, anti-roll bars are typically heavy, increase the system complexity and parts count, and require significant packaging space within a vehicle.

The disadvantages associated with these conventional suspension techniques have made it apparent that a new technique for suspensions is needed. The new technique should integrate multiple automotive suspension functions into one integral unit. Additionally, the new technique should reduce part count and weight while improving NVH and reducing complexity. The present invention is directed to these ends.

### SUMMARY OF THE INVENTION

It is, therefore, an object of the invention to provide an improved and reliable integrated cross-car suspension system with MacPherson strut. Another object of the invention is to reduce part count and weight while potentially improving NVH and reducing complexity.

In accordance with the objects of this invention, an integrated cross-car suspension system with MacPherson strut is provided. In one embodiment of the invention, a cross-car suspension system with MacPherson strut replaces the lower control arms, coil springs, and anti-roll bar assembly in the prior art with a composite beam. By carefully designing the shape of the beam, the material system and the pivot locations, the ride and roll rates and camber and toe characteristics of the original prior art suspension system can be preserved.

The present invention thus achieves an improved integrated cross-car suspension system with MacPherson struts. The present invention is advantageous in that it integrates multiple automotive suspension functions into one integral unit.

Additional advantages and features of the present invention will become apparent from the description that follows, and may be realized by means of the instrumentalities and combinations particularly pointed out in the appended claims, taken in conjunction with the accompanying drawings.

### BRIEF DESCRIPTION OF THE DRAWINGS

In order that the invention may be well understood, there will now be described some embodiments thereof, given by way of example, reference being made to the accompanying drawings, in which:

FIG. 1 is an illustration of a composite beam according to a preferred embodiment of the present invention;

FIG. 2 is a cross section of a 3D woven preform part for a composite beam in accordance with a preferred embodiment of the present invention;

FIG. 3 is an illustration of a integrated front cross-car suspension system with MacPherson strut having the composite beam of FIG. 1 in accordance with one embodiment of the present invention;

FIG. 4 is an illustration of a integrated rear cross-car suspension system with MacPherson strut having the composite beam of FIG. 1 in accordance with one embodiment of the present invention;

FIG. 5 is section view of the composite spring of FIG. 4 taken along line 5-5; and

FIG. 6 is section view of the attachment point of the composite spring of FIG. 5 taken along line 6-6.

### BEST MODES FOR CARRYING OUT THE INVENTION

In the following figures, the same reference numerals will be used to identify identical components in the various views. The present invention is illustrated with respect to an integrated cross-car suspension system with MacPherson strut, particularly suited for the automotive field. However, the present invention is applicable to various other uses that may require cross-car suspension system with MacPherson struts.

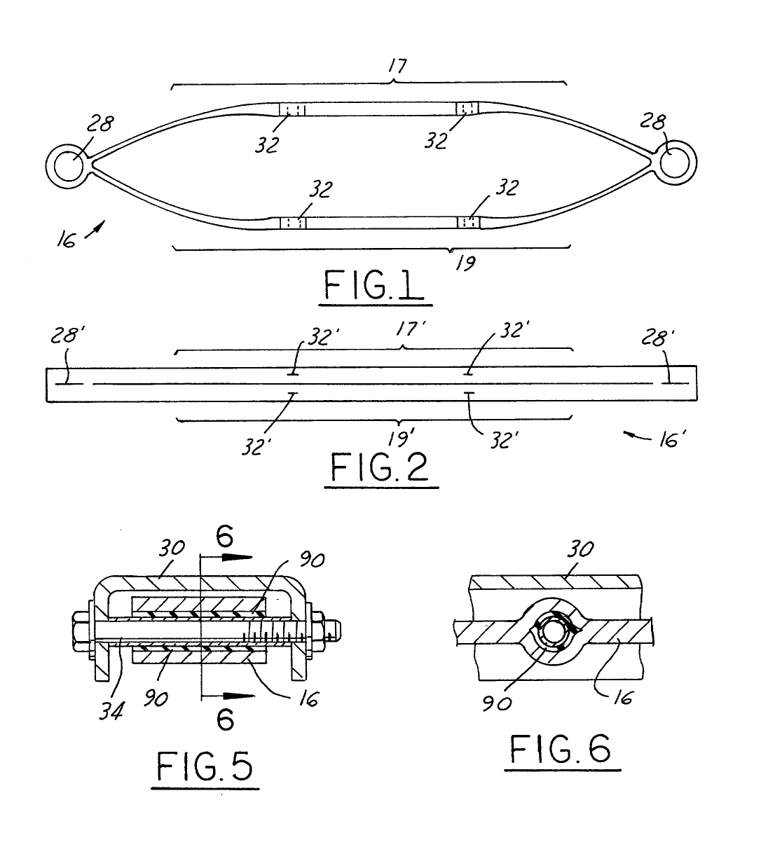

Referring now to FIG. 1, a front composite beam 16 in accordance with a preferred embodiment of the present invention is depicted as having a leading portion 17, a trailing portion 19, and a pair of attachment holes 28 formed between each end of the leading portion 17 and the trailing portion 19. The leading portion 17 and trailing portion 19 each have attachment pivots 32. The front composite beam 16 is preferably composed of a fiber-reinforced thermoset or thermoplastic polymer laminate material. Preferably, the polymer used in the composite laminate layers is an epoxy resin. The method for making the front composite beam 16 is described below in FIG. 2.

Referring to FIG. 2, a cross section of a 3D woven preform 16′ for a composite beam 16 in accordance with one embodiment of the present invention is illustrated. In this process, multiple spools of fiber (glass and/or carbon) feed fiber into a weaving machine that loops the fiber across the width and through the thickness, with a majority of the fibers running along the length of the composite beam preform. The initial preform would be approximately 1.5 m wide and may be manufactured using a 3D textile weaving process. Approximately 50 mm of the initial preform would be cut off for each preform 16′. The preform section 17′ and the preform section 19′ would be separated and twisted ninety degrees to form the leading portion 17 and trailing portion 19 of the composite beam 16. Sacrificial inserts would be placed into the preform slits, corresponding to the attachment holes 28′ and a pair of attachment pivots 32′ thereby expanding them into holes that are used to form the attachment holes 28 and pair of attachment pivots 32, respectively. This preform 16′ could then be placed in a mold and consolidated with resin using a resin transfer molding (RTM) or vacuum-assisted resin transfer molding (VARTM) process to form the finished composite beam 16.

The composite beam 16 may also be made using other composite manufacturing techniques. These techniques may include the use of fiber pre-impregnated with resin, dry fibers consolidated using either the RTM or VARTM process, filament winding, textile braiding, or other composite manufacturing techniques known in the art.

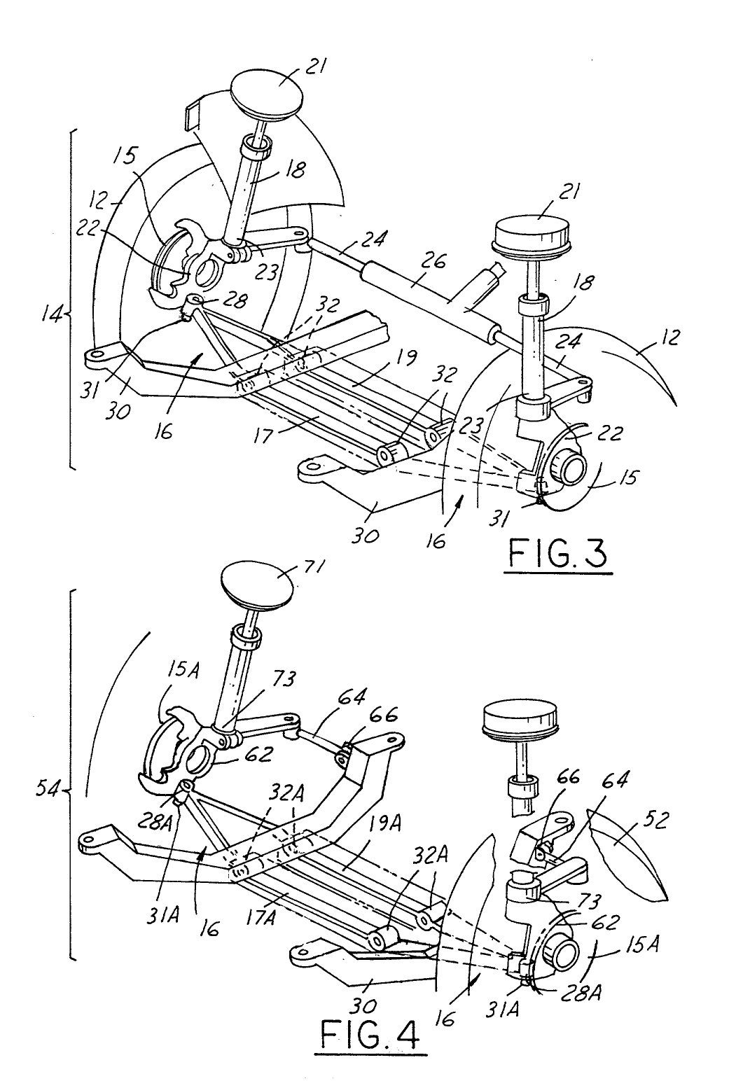

FIGS. 3 and 4 illustrate a front and rear cross car suspension system with a MacPherson Strut. The cross-car suspension system with MacPherson strut replaces the lower control arms, upper control arms, coil springs, and anti-roll bar assembly in the prior art with a simple composite beam. By carefully designing the shape of the beam, the material system and the attachment pivot locations, the ride and roll rates and camber and toe characteristics of the original prior art MacPherson suspension system can be preserved.

Referring to FIG. 3, an integrated cross-car front suspension system with MacPherson strut 14 in accordance with one embodiment of the present invention is illustrated. A motor vehicle chassis (not shown) (or unitized body and chassis) is supported on left and right front road wheels 12 by a front wheel suspension system 14. The front wheel suspension system 14 includes a front composite beam 16 and a pair of front struts 18, or damper.

Each front upper end 21 of a respective front strut 18 is rotatably coupled via a spherical joint to a vehicle body, or chassis (not shown), while each front lower end 23 of the front strut 18 is coupled to a front knuckle 22. The front knuckle 22 is also coupled to a respective left or right road front wheels 12 through a front hub 15. In addition, a steering tie rod 24 is coupled between the steering rack 26 and the front knuckle 22. The front composite beam 16 is coupled to each of the front knuckles 22 via a front attachment hole 28. A steel lower ball joint 31 is preferably pressed (or bonded) within each front attachment hole 28 prior to coupling the front composite beam 16 to the front knuckle 22. In addition, the front attachment pivots 32 of the front leading portion 17 and front trailing portion 19 are each used for coupling the front composite beam 16 to the vehicle subframe 30. A close-up view for coupling the front composite beam 16 to the vehicle subframe 30 is shown below in FIGS. 5 and 6.

Referring to FIG. 4, a rear suspension system with MacPherson strut 54 in accordance with one embodiment of the present invention is illustrated. A motor vehicle chassis (not shown) (or unitized body and chassis) is supported on left and right rear road wheels 52 by a rear wheel suspension system 54. The rear wheel suspension system 54 includes a rear composite beam 16A and a pair of rear struts 58, or rear dampers. The rear composite beam 16A is sized, shaped, and manufactured similarly to the front composite beam 16 as described above in FIGS. 1 and 2. In order to differentiate between the front 16 and rear 16A composite beam, for simplicity sake, similar features on the rear composite beam 16A are denoted with an A. Thus, for example, the trailing portion of the front composite beam is listed as 19, while the trailing portion of the rear composite beam is listed as 19A.

Each rear upper end 71 of a respective rear strut 58 is rotatably coupled via a spherical joint to a vehicle body, or chassis (not shown), while each rear lower end 73 is coupled to a rear knuckle 62. The rear knuckle 62 is also coupled to a respective left or right rear road wheel 52 through a rear hub 55. In addition, a toe link 64 is coupled to the vehicle subframe 30 via a pivot 66 and to the rear knuckle 62. The rear composite beam 16A is coupled to the rear knuckle 62 via a pair of rear attachment holes 28A. A steel lower ball joint 31A is preferably pressed (or bonded) within each each front attachment hole 28A prior to coupling the rear composite beam 16A to the rear knuckle 62. In addition, the rear attachment pivots 32A of the rear leading portion 17A and rear trailing portion 19A are each used for coupling the rear composite beam 16A to the vehicle subframe 30.

Referring now to FIGS. 5 and 6, a close-up view of the coupling the front composite beam 16 to the vehicle subframe 30 is depicted. In FIGS. 5 and 6, a bolt assembly 34 is preferably used to secure the front leading portion 17 and front trailing portion 19 of the front composite beam 16 to the vehicle subframe 30 through their respective front attachment pivots 32. Typically, the composite beam 16 would be isolated from the subframe using a rubber bushing 90. Of course, in other embodiments, any number of other methods known in the art may be used for securing the front composite beam 16, to the vehicle subframe 30 through the front attachment pivots 32. While not depicted, the rear composite beam 16A is coupled to the subframe 30 in a similar manner as is shown in FIGS. 5 and 6.

The present invention thus achieves an improved and reliable integrated cross-car suspension system with MacPherson strut by using a composite beam. In this way, the present invention integrates multiple automotive suspension functions into one integral unit. This results in a reduction in part count and weight while improving potentially NVH and reducing overall complexity.

In addition, because coil spring function is integrated into the composite beam, no coil springs are needed. In the present invention, therefore, the strut portion provides the damping and locating functions. As such, the damper height can be reduced, thereby requiring less packaging space within the vehicle. This in turn allows greater freedom in the design of the exterior body surface of vehicles.

From the foregoing, it can be seen that there has been brought to the art a new and improved wheel suspension system having an integrated control arm, spring, and anti-roll bar. It is to be understood that the preceding description of the preferred embodiment is merely illustrative of some of the many specific embodiments that represent applications of the principles of the present invention. Clearly, numerous and other arrangements would be evident to those skilled in the art without departing from the scope of the invention as defined by the following claims:

What is claimed is:

1. A front cross-car suspension with MacPherson strut for a vehicle comprising:
a chassis;
a pair of front road wheels, each of said pair of front road wheels coupled to a front hub;
a pair of front knuckles, one of said pair of front knuckles coupled to a respective one of said front hubs;
a pair of front struts each having a front upper end and a front lower end, said front upper end of said front strut rotatably coupled (spherical joint) to said chassis, said front lower end of said front struts coupled to one of said front knuckles;
a vehicle subframe coupled to said chassis; and
a front composite beam having a front leading portion and a front trailing portion joined at a pair of front attachment holes, said front leading portion and said front trailing portion of said front composite beam each having a front attachment pivot, said front attachment holes rotatably coupled to each of said pair of front knuckles, and each of said front attachment pivots rotatably coupled to said vehicle subframe, wherein said front composite beam controls the ride and roll stiffness and location of said pair of front road wheels.

2. The front cross-car suspension with MacPherson strut for a vehicle as recited in claim 1, wherein said chassis is a unitized body.

3. The front cross-car suspension with MacPherson strut for a vehicle as recited in claim 1, further comprising a pair of steering tie rods and a steering rack, each of said steering tie rods coupled between said steering rack and a respective one of said pair of front knuckles.

4. The front cross-car suspension with MacPherson strut for a vehicle as recited in claim 1, wherein said front composite beam is composed of a fiber-reinforced polymer laminate material.

5. The front cross-car suspension with MacPherson strut for a vehicle as recited in claim 1, wherein said fiber-reinforced polymer laminate material comprises a fiber material and an epoxy resin, said fiber material selected from the group consisting of carbon fiber and glass fiber.

6. A rear cross-car suspension with MacPherson strut for a vehicle comprising:
a chassis;
a pair of rear road wheels, each of said pair of rear road wheels coupled to a rear hub;
a pair of rear knuckles, one of said pair of rear knuckles coupled to a respective one of said rear hubs;
a pair of rear struts each having an rear upper end and a rear lower end, said rear upper end of said rear strut rotatably coupled (spherical joint) to said chassis, said rear lower end of said rear strut coupled to one of said rear knuckles;
a vehicle subframe coupled to said chassis; and
a rear composite beam having a rear leading portion and a rear trailing portion joined at a pair of rear attachment holes, said rear leading portion and said rear trailing portion of said rear composite beam each having a rear attachment pivot, said rear attachment holes rotatably coupled to each of said pair of rear knuckles, and each of said rear attachment pivots rotatably coupled to said vehicle subframe, wherein said rear composite beam controls the ride and roll stiffness and location of said pair of rear road wheels.

7. The rear cross-car suspension with MacPherson strut for a vehicle as recited in claim 6, wherein said chassis is a unitized body.

8. The rear cross-car suspension with MacPherson strut for a vehicle as recited in claim 6, further comprising a toe link, said toe link coupled between said pair of rear knuckles and coupled to said vehicle subframe.

9. The rear cross-car suspension with MacPherson strut for a vehicle as recited in claim 1, wherein said rear composite beam is composed of a fiber-reinforced polymer laminate material.

10. The rear cross-car suspension with MacPherson strut for a vehicle as recited in claim 1, wherein said fiber-reinforced polymer laminate material comprises a fiber material and an epoxy resin, said fiber material selected from the group consisting of carbon fiber and glass fiber.

11. A cross-car suspension with MacPherson strut for a vehicle comprising:
a chassis;
a pair of front road wheels, each of said pair of front road wheels coupled to a front hub;
a pair of rear road wheels, each of said pair of rear road wheels coupled to a rear hub;
a pair of front knuckles, one of said pair of front knuckles coupled to a respective one of said front hubs;
a pair of rear knuckles, one of said pair of rear knuckles coupled to a respective one of said rear hubs;
a pair of front struts each having an upper end and a lower end, said upper end of said strut rotatably coupled (spherical joint) to said chassis, said lower end of said strut coupled to one of said front knuckles;
a pair of rear struts each having a rear upper end and a rear lower end, said rear upper end of said rear strut rotatably coupled (spherical joint) to said chassis, said rear lower end of said strut coupled to one of said rear knuckles;
a vehicle subframe coupled to said chassis;
a front composite beam having a front leading portion and a front trailing portion joined at a pair of front attachment holes, said front leading portion and said front trailing portion of said front composite beam each having a front attachment pivot, said front attachment holes rotatably coupled to each of said pair of front knuckles, and each of said front attachment pivots rotatably coupled to said vehicle subframe, wherein said front composite beam controls a ride and roll rate and location of said pair of front road wheels; and
a rear composite beam having a rear leading portion and a rear trailing portion joined at a pair of rear attachment holes, said rear leading portion and said rear trailing portion of said rear composite beam each having a rear attachment pivot, said rear attachment holes rotatably coupled to each of said pair of rear knuckles, and each of said rear attachment pivots rotatably coupled to said vehicle subframe, wherein said rear composite beam controls a ride and roll rate and location of said pair of rear road wheels.

12. The front cross-car suspension with MacPherson strut for a vehicle as recited in claim 11, wherein said chassis is a unitized body.

13. The front cross-car suspension with MacPherson strut for a vehicle as recited in claim 11, further comprising a pair of steering tie rods and a steering rack, each of said steering tie rods coupled between said steering rack and a respective one of said pair of front knuckles.

14. The front cross-car suspension with MacPherson strut for a vehicle as recited in claim 11, wherein said front composite beam and said rear composite beam are each composed of a fiber-reinforced polymer laminate material.

15. The rear cross-car suspension with MacPherson strut for a vehicle as recited in claim 14, wherein said fiber-reinforced polymer laminate material comprises a fiber material and an epoxy resin, said fiber material selected from the group consisting of carbon fiber and glass fiber.

16. The rear cross-car suspension with MacPherson strut for a vehicle as recited in claim 11, further comprising a toe link, said toe link coupled between said pair of rear knuckles and coupled to said vehicle subframe.
